(19) United States
(12) Patent Application Publication
(10) Pub. No.: US 2016/0330563 A1
(43) Pub. Date: Nov. 10, 2016

(54) VIRTUAL REALITY AUDIO SYSTEM AND THE PLAYER THEREOF, AND METHOD FOR GENERATION OF VIRTUAL REALITY AUDIO

(71) Applicant: HTC Corporation, Taoyuan City (TW)

(72) Inventors: Lei CHEN, Taoyuan City (TW); Ho-Shen HSU, Taoyuan City (TW); Chun-Min LEE, Taoyuan City (TW); Hann-Shi TONG, Taoyuan City (TW)

(73) Assignee: HTC Corporation, Taoyuan City (TW)

(21) Appl. No.: 15/134,662

(22) Filed: Apr. 21, 2016

Related U.S. Application Data
(60) Provisional application No. 62/158,919, filed on May 8, 2015.

(51) Int. Cl. H04S 7/00; H04R 5/033; H04S 1/00; H04R 5/04

(52) U.S. Cl. CPC H04S 7/304; H04R 5/04; H04R 5/033; H04S 1/007; H04S 2400/15

(57) ABSTRACT

A virtual reality audio player having left- and right-ear speakers, a motion detection module and a processor is disclosed. The left- and right-ear speakers are operative to play left- and right-ear sounds, respectively. The motion detection module collects motion information about the listener of the left- and right-ear speakers. The processor converts multiple sound tracks into the left- and right-ear sounds based on the motion information detected by the motion detection module and a microphone array structure. The multiple sound tracks are provided by multiple microphones forming the microphone array structure.

### CROSS REFERENCE TO RELATED APPLICATIONS

This application claims the benefit of U.S. Provisional Application No. 62/158,919, filed May 8, 2015, the entirety of which is incorporated by reference herein.

### BACKGROUND OF THE INVENTION

1. Field of the Invention

The present invention relates to a virtual reality (VR) audio system.

2. Description of the Related Art

Virtual reality (VR) replicates an environment that simulates a physical presence in places in the real world or an imagined world, allowing the user to interact with that world. Virtual realities artificially create sensory experience, e.g., hearing.

In a VR audio system, simulations focus on real sound produced through speakers or headphones targeted towards the VR user. It is an important topic to improve the realism of the sound simulation.

### BRIEF SUMMARY OF THE INVENTION

A virtual reality audio player in accordance with an exemplary embodiment of the disclosure has left- and right-ear speakers, a motion detection module and a processor is disclosed. The left- and right-ear speakers are operative to play left- and right-ear sounds, respectively. The motion detection module collects motion information about a listener of the left- and right-ear speakers. The processor converts multiple sound tracks into the left- and right-ear sounds based on the motion information detected by the motion detection module and a microphone array structure. The multiple sound tracks are provided by multiple microphones forming the microphone array structure.

A virtual reality audio system in accordance with an exemplary embodiment of the disclosure has the aforementioned virtual reality audio player and at least three microphones for sound track recording for the virtual reality audio player.

A method for generation of virtual reality audio in accordance with an exemplary embodiment includes the following steps: using a left-ear speaker and a right-ear speaker to play a left-ear sound and a right-ear sound, respectively; collecting motion information about a listener of the left-ear speaker and the right-ear speaker; and converting multiple sound tracks into the left-ear sound and the right-ear sound based on the motion information and a microphone array structure, wherein the multiple sound tracks are provided by multiple microphones forming the microphone array structure.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 depicts a virtual reality audio player 100 in accordance with an exemplary embodiment of the disclosure;

FIG. 2A depicts a rotation angle θ around a vertical axis Z that may be detected by the motion detection module 106;

FIG. 2B depicts a rotation angle Φ around a horizontal axis X that may be detected by the motion detection module 106;

FIG. 3 is a flowchart depicting how the virtual reality audio player 100 works in accordance with an exemplary embodiment of the disclosure;

FIG. 4 shows a virtual reality audio system 400 in accordance with an exemplary embodiment of the disclosure, which has the aforementioned virtual reality audio player 100, a microphone array 402 and a storage medium 404;

FIG. 5A shows a regular triangle microphone array including three microphones Pa, Pb and Pc at the three ends;

FIG. 5B is a flowchart depicting how the VR audio player 100 works with respect to the multiple sound tracks Pa, Pb and Pc received by the regular triangle microphone array of FIG. 5A; and

FIG. 6 shows a handhold device 600 having the three microphones Pa, Pb and Pc (atop the device 600).

### DETAILED DESCRIPTION OF THE INVENTION

The following description shows exemplary embodiments carrying out the invention. This description is made for the purpose of illustrating the general principles of the invention and should not be taken in a limiting sense. The scope of the invention is best determined by reference to the appended claims.

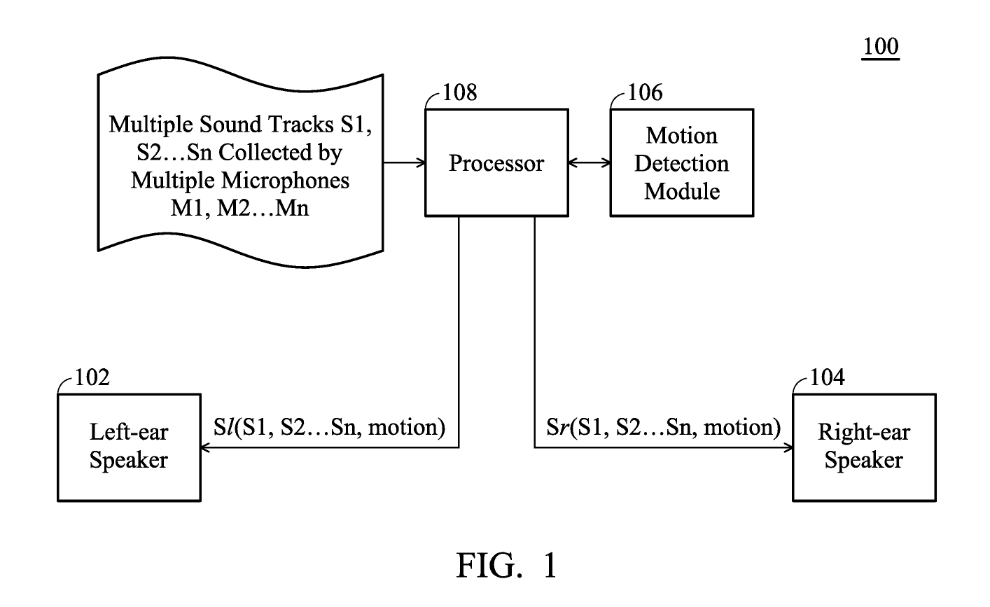

FIG. 1 depicts a virtual reality (VR) audio player 100 in accordance with an exemplary embodiment of the disclosure. The virtual reality audio player 100 includes a left-ear speaker 102, a right-ear speaker 104, a motion detection module 106 and a processor 108. The left-ear speaker 102 and the right-ear speaker 104 are operative to play a left-ear sound Sl and a right-ear sound Sr, respectively. The motion detection module 106 collects motion information about a listener (i.e. a VR user) of the left-ear speaker 102 and the right-ear speaker 104. The processor 108 converts multiple sound tracks S1, S2 . . . Sn into the left-ear sound Sl and the right-ear sound Sr based on the motion information detected by the motion detection module 106 and a microphone array structure. The multiple sound tracks S1, S2 . . . Sn are provided by multiple microphones M1, M2 . . . Mn forming the microphone array structure. The processor 108 may calculate the left-ear sound Sl according to a mathematical equation Sl(S1, S2 . . . Sn, motion) and the right-ear sound Sr according to a mathematical equation Sr(S1, S2 . . . Sn, motion). According to the mathematical equations Sl(S1, S2 . . . Sn, motion) and Sr(S1, S2 . . . Sn, motion), the motion of the VR user and the microphone array structure of the microphones M1, M2 . . . Mn collecting the sound tracks S1, S2 . . . Sn are taken into consideration in the generation of the left-ear sound Sl and the right-ear sound Sr.

In an exemplary embodiment, the processor 108 generates the left-ear sound Sl and the right-ear sound Sr to simulate a perception difference between a left ear and a right ear of the VR user. In another exemplary embodiment, the processor 108 generates the left-ear sound Sl and the right-ear sound Sr to simulate a Doppler Effect. In other exemplary embodiments, the processor 108 generates the left-ear sound Sl and the right-ear sound Sr to simulate the perception difference and the Doppler Effect both.

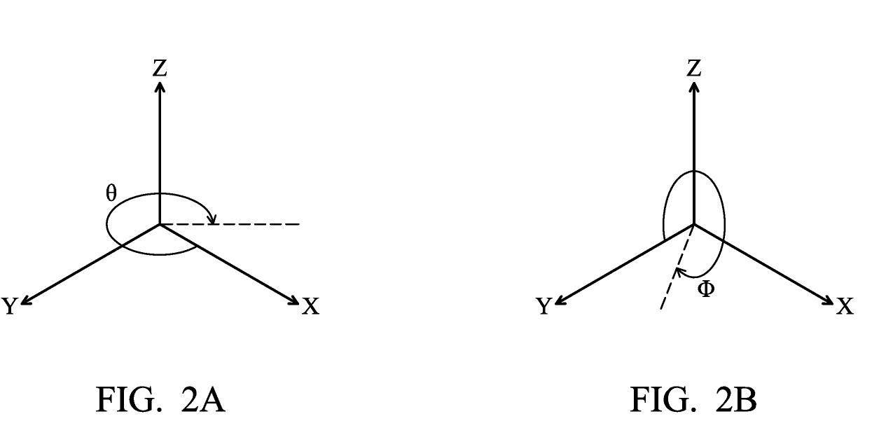

To simulate the hearing different or/and the Doppler Effect, the motion detection module 106 may detect the rotation of the VR user around a vertical axis or/and a horizontal axis. FIG. 2A depicts a rotation angle θ around a vertical axis Z that may be detected by the motion detection module 106. FIG. 2B depicts a rotation angle Φ around a horizontal axis X that may be detected by the motion detection module 106. In some exemplary embodiments, the motion detection module 106 may further detect an acceleration of the VR user to form the motion information. The motion information about the VR user (e.g., θ or/and Φ or/and the acceleration detected by the motion detection module 106) may be continuously collected to show where the VR user is and how the VR user acts in a VR environment (in the real world or an imagined world) and, accordingly, the left-ear sound Sl and the right-ear sound Sr are separately modified by weighting factor modification of the multiple sound tracks S1 . . . Sn.

Simulation of the perception difference experienced by the VR user is discussed in this paragraph. When the motion information detected by the motion detection module 106 shows that the VR user originally facing forward in a virtual reality environment is turning to the right side or to the left side of the virtual reality environment, the processor 108 generates the right-ear sound Sr by gradually depressing the weighting factor of the right-ear sound track and gradually enhancing the weighting factor of the left-ear sound track, and generates the left-ear sound Sl by gradually depressing the weighting factor of the left-ear sound track and gradually enhancing the weighting factor of the right-ear sound track. The right-ear sound track is one of the sound tracks S1, S2 . . . Sn and corresponds to the right side of the virtual reality environment. The left-ear sound track is one of the sound tracks S1, S2 . . . Sn and corresponds to the left side of the virtual reality environment.

The simulation of the Doppler Effect is discussed in this paragraph. The processor 108 may gradually enhance frequencies of the left-ear sound Sl and the right-ear sound Sr when the motion information detected by the motion detection module 106 shows that the VR user is approaching an audio source in the virtual reality environment. Furthermore, the processor 108 may gradually depress the frequencies of the left-ear sound Sl and the right-ear sound Sr when the motion information detected by the motion detection module 106 shows that the VR user is moving away from the audio source in the virtual reality environment.

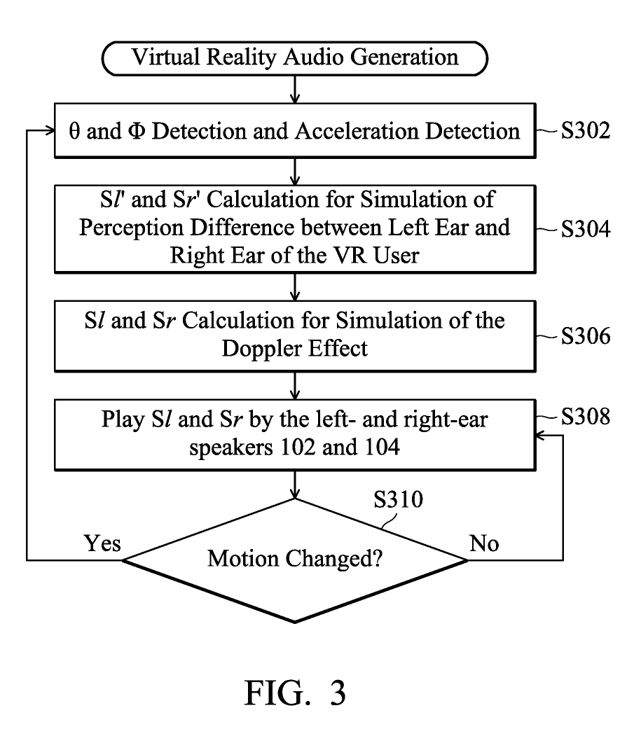

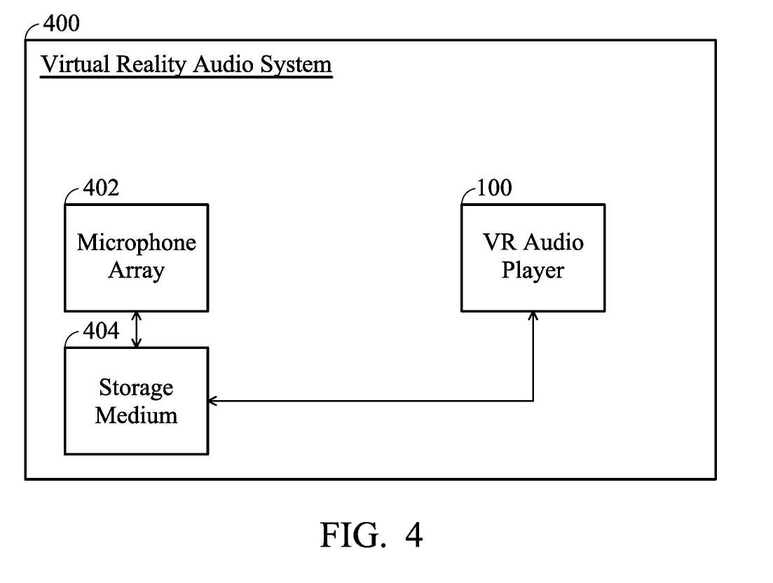

FIG. 3 is a flowchart depicting how the virtual reality audio player 100 works in accordance with an exemplary embodiment of the disclosure. In step S302, the motion information about the VR user is collected by the motion detection module 106. A rotation angle θ around a vertical axis Z, a rotation angle Φ around a horizontal axis X, and the acceleration of the VR user are detected. In step S304, the processor 108 converts the multiple sound tracks S1, S2 . . . Sn to a left-ear sound Sl′ and a right-ear sound Sr′ based on the structure of the microphone array M1, M2 . . . Mn and the orientation of the VR user (e.g. the rotation angles θ and Φ). The perception difference between the left and right ears of the VR user is taken into consideration in the generation of the left-ear and right-ear sounds Sl′ and Sr′. In step S306, in addition to the microphone array structure and the rotation angles θ and Φ, the processor 108 takes the detected acceleration of the VR user into further consideration to transform the left-ear and right-ear sounds Sl′ and Sr′ to Sl and Sr, respectively, to emulate the Doppler Effect. For example, the processor 108 may enhance frequencies of the left-ear sound Sl′ and the right-ear sound Sr′ step by step (e.g., gradually) to generate the left-ear sound Sl and the right-ear sound Sr when the motion information shows that the VR user is approaching an audio source in the VR environment, and may depress frequencies of the left-ear sound Sl′ and the right-ear sound Sr′ step by step (e.g., gradually) to generate the left-ear sound Sl and the right-ear sound Sr when the motion information shows that the VR user is moving away from the audio source in the VR environment. In step S308, the left-ear speaker 102 plays the left-ear sound Sl and the right-ear speaker 104 plays the right-ear sound Sr. Step S310 checks whether the VR user changes his motion (according to the motion information, e.g. rotation angles θ and Φ and the acceleration of the VR user detected by the motion detection module 106). If yes, step S302 is performed to confirm the new rotation angles θ and Φ and the new acceleration and then steps S304 to S308 are performed based on the new motion information. If the VR user does not change his motion, the flow stays in step S308.

In other exemplary embodiments, rotation angles θ and Φ and the acceleration of the VR user (i.e. motion factors) may not all be taken into consideration in the generation of the left-ear sound Sl and the right-ear sound Sr. For simplicity, it is allowed to take just part of the motion factors into consideration when generating the left-ear and right-ear sounds Sl and Sr. The motion detection module 106 may include but not limited to a G sensor, a compass and an accelerometer.

FIG. 4 shows a virtual reality audio system 400 in accordance with an exemplary embodiment of the disclosure, which has the aforementioned virtual reality audio player 100, a microphone array 402 and a storage medium 404. The microphone array 402 has at least three microphones for sound track recording for the virtual reality audio player 100. The storage medium 404 stores a record of sound tracks to be retrieved by the virtual reality audio player 100.

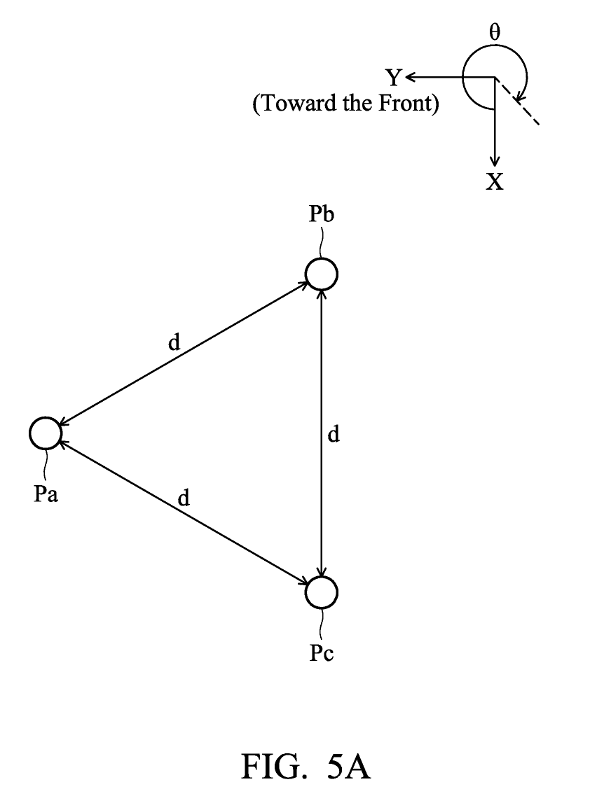

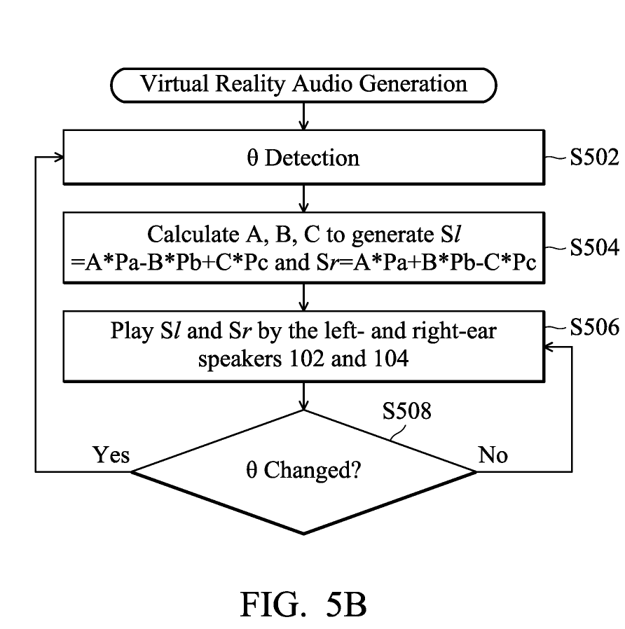

FIG. 5A shows a regular triangle microphone array including three microphones Pa, Pb and Pc at the three ends. The three sound tracks received by the microphones Pa, Pb and Pc are also named Pa, Pb and Pc. The space, d, between any two microphones may be designed to be 343(m/s)/(2*fc(Hz)). For space aliasing of 16 KHz (fc=16 KHz), the space, d, between any two microphones may be 1 cm (obtained from 343(m/s)/(2*16K(Hz))). The microphone Pa is regarded as a front microphone in a virtual reality environment where the axis Y toward the front.

FIG. 5B is a flowchart depicting how the VR audio player 100 works with respect to the multiple sound tracks Pa, Pb and Pc received by the regular triangle microphone array of FIG. 5A. In step S502, the rotation angle θ of the VR user around the vertical axis Z is detected. In step S504, the processor 108 calculates weighting factors A, B and C corresponding to the detected rotation angle θ and calculates A*Pa−B*Pb+C*Pc as the left-ear sound Sl and A*Pa+B*Pb−C*Pc as the right-ear sound Sr. In step S506, the left-ear speaker 102 plays the left-ear sound Sl and the right-ear speaker 104 plays the right-ear sound Sr. Step S508 checks whether the rotation angle θ changes. If yes, step S502 is performed to confirm the new rotation angle θ and then steps S504 to S506 are performed based on the new rotation angle θ. If the VR user does not change his rotation angle θ, the flow stays in step S506. In this example, the sound track Pb may be regarded as a right-ear sound track and the sound track Pc may be regarded as a left-ear sound track. When the VR user originally facing toward turns right or turns left around the axis Z, the weighting factors B and C may decrease.

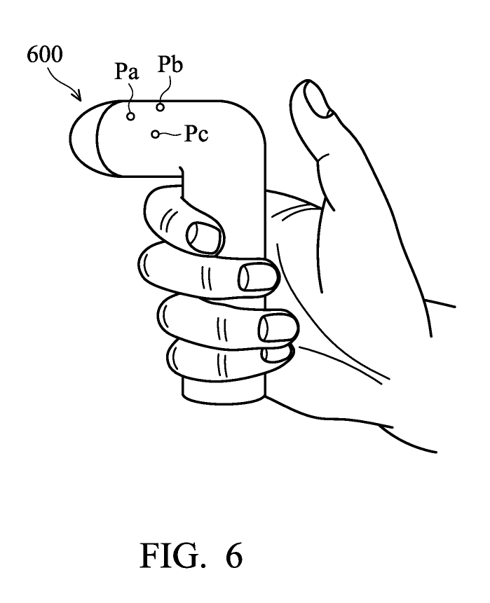

FIG. 6 shows a handhold device 600 having the three microphones Pa, Pb and Pc (atop the device 600).

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A virtual reality audio player, comprising:
a left-ear speaker and a right-ear speaker for playing a left-ear sound and a right-ear sound, respectively;
a motion detection module, collecting motion information about a listener of the left-ear speaker and the right-ear speaker; and
a processor, converting multiple sound tracks into the left-ear sound and the right-ear sound based on the motion information detected by the motion detection module and a microphone array structure,
wherein the multiple sound tracks are provided by multiple microphones forming the microphone array structure.

2. The virtual reality audio player as claimed in claim 1, wherein:
the processor generates the left-ear sound and the right-ear sound to simulate a perception difference between a left ear and a right ear of the listener.

3. The virtual reality audio player as claimed in claim 2, wherein:
when the motion information detected by the motion detection module shows that the listener originally facing forward in a virtual reality environment is turning to a right side or to a left side of the virtual reality environment, the processor generates the right-ear sound by gradually depressing a weighting factor of a right-ear sound track and gradually enhancing a weighting factor of a left-ear sound track and generates the left-ear sound by gradually depressing the weighting factor of the left-ear sound track and gradually enhancing the weighting factor of the right-ear sound track;
the right-ear sound track is one of the sound tracks and corresponds to the right side of the virtual reality environment; and
the left-ear sound track is one of the sound tracks and corresponds to the left side of the virtual reality environment.

4. The virtual reality audio player as claimed in claim 3, wherein:
the motion detection module detects a rotation angle of the listener around a vertical axis of the virtual reality environment as the motion information.

5. The virtual reality audio player as claimed in claim 1, wherein:
the processor generates the left-ear sound and the right-ear sound to simulate a Doppler Effect.

6. The virtual reality audio player as claimed in claim 5, wherein:
the processor gradually enhances frequencies of the left-ear sound and the right-ear sound when the motion information detected by the motion detection module shows that the listener is approaching an audio source in a virtual reality environment; and
the processor gradually depresses the frequencies of the left-ear sound and the right-ear sound when the motion information detected by the motion detection module shows that the listener is moving away from the audio source in the virtual reality environment.

7. The virtual reality audio player as claimed in claim 6, wherein:
the motion detection module detects a rotation angle of the listener around a vertical axis in the virtual reality environment, a rotation angle of the listener around a horizontal axis in the virtual reality environment, and an acceleration of the listener to form the motion information.

8. A virtual reality audio system, comprising:
the virtual reality audio player as claimed in claim 1; and
at least three microphones for sound track recording for the virtual reality audio player.

9. The virtual reality audio system as claimed in claim 8, further comprising:
a storage medium, storing a record of sound tracks to be retrieved by the virtual reality audio player.

10. A method for generation of virtual reality audio, comprising:
using a left-ear speaker and a right-ear speaker to play a left-ear sound and a right-ear sound, respectively;
collecting motion information about a listener of the left-ear speaker and the right-ear speaker; and
converting multiple sound tracks into the left-ear sound and the right-ear sound based on the motion information and a microphone array structure,
wherein the multiple sound tracks are provided by multiple microphones forming the microphone array structure.

11. The method for generation of virtual reality audio as claimed in claim 10, wherein:
the left-ear sound and the right-ear sound are generated to simulate a perception difference between a left ear and a right ear of the listener.

12. The method for generation of virtual reality audio as claimed in claim 11, wherein:
when the motion information shows that the listener originally facing forward in a virtual reality environment is turning to a right side or to a left side of the virtual reality environment, the right-ear sound is generated by gradually depressing a weighting factor of a right-ear sound track and gradually enhancing a weighting factor of a left-ear sound track and the left-ear sound is generated by gradually depressing the weighting factor of the left-ear sound track and gradually enhancing the weighting factor of the right-ear sound track;
the right-ear sound track is one of the sound tracks and corresponds to the right side of the virtual reality environment; and
the left-ear sound track is one of the sound tracks and corresponds to the left side of the virtual reality environment.

13. The method for generation of virtual reality audio as claimed in claim 12, wherein:
a rotation angle of the listener around a vertical axis of the virtual reality environment is detected as the motion information.

14. The method for generation of virtual reality audio as claimed in claim 10, wherein:
the left-ear sound and the right-ear sound are generated to simulate a Doppler Effect.

15. The method for generation of virtual reality audio as claimed in claim 14, wherein:
frequencies of the left-ear sound and the right-ear sound are gradually enhanced when the motion information shows that the listener is approaching an audio source in a virtual reality environment; and
the frequencies of the left-ear sound and the right-ear sound are gradually depressed when the motion information shows that the listener is moving away from the audio source in the virtual reality environment.

16. The virtual reality audio player as claimed in claim 15, wherein:
a rotation angle of the listener around a vertical axis in the virtual reality environment, a rotation angle of the listener around a horizontal axis in the virtual reality environment, and an acceleration of the listener are detected to form the motion information.
